(19) United States
(12) Patent Application Publication
(10) Pub. No.: US 2005/0203227 A1
(43) Pub. Date: Sep. 15, 2005

(54) Nanofiller, production, and use

(75) Inventors: Adolf Kuhnle, Marl (DE); Carsten Jost, Marl (DE); Hendrikus Cornelis Louis Abbenhuis, Nuenen (NL)

Correspondence Address: OBLON, SPIVAK, MCCLELLAND, MAIER & NEUSTADT, P.C., 1940 DUKE STREET, ALEXANDRIA, VA, 22314, US

(73) Assignee: CREAVIS Gesellschaft fuer Tech. und Innovation mbH, Marl (DE)

(21) Appl. No.: 10/512,080

(22) PCT Filed: May 2, 2003
(86) PCT No.: PCT/EP03/04586

§ 371 Date: May 5, 2005

(30) Foreign Application Priority Data
May 15, 2002 (DE) 102 21 872.2
Jan. 18, 2003 (DE) 103 01 754.2

(51) Int. Cl. C04B 14/04; C08K 5/24

(52) U.S. Cl. 524/261; 106/481

(57) ABSTRACT

The invention relates to a sub-20 nm nanofiller for use in a matrix material, to the matrix resulting therefrom, to a process for preparing said matrix, and to the use of said nanofiller, the nanofiller comprising functionalized polyhedral oligomeric silicon-oxygen cluster units of the formula
[(RₐX_{b}SiO_{1.5})ₘ(R_{c}X_{d}SiO)ₙ(RₑX_{f}Si_{2.05})ₒ(R_{g}XₕSi₂O₂)ₚ] with: a, b, c=0-1; d=1-2; e, g, f=0-3; h=1-4; m·b+n·d+o·f+p·h≦4; m+n+o+p≧4; a+b=1; c+d=2; e+f=3 and g+h=4; R=hydrogen atom, alkyl, cycloalkyl, alkenyl, cycloalkenyl, alkynyl, cycloalkynyl, aryl, heteroaryl group or polymer unit, which are in each case substituted or unsubstituted, or further functionalized polyhedral oligomeric silicon-oxygen cluster units, which are attached by way of a polymer unit or a bridging unit, X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R containing at least one such group of the type X, the substituents of the type R being identical or different and the substituents of the type X being identical or different, with the proviso that there are not more than four substituents of the type X per cluster unit.

The invention relates to a nanofiller, to its use in organic and/or inorganic matrix materials and to the matrix resulting therefrom.

Fillers have for many years had a high significance in the plastics industry. Fillers are basically understood to be additives in solid form, which differ from the polymer matrix in terms of their composition and structure. They generally comprise inorganic materials, more rarely organic materials. Inactive fillers or extenders raise the quantity and lower the prices, while active fillers bring about targeted improvements in certain mechanical or physical properties. The activity of active fillers may have a variety of causes, such as the formation of a chemical bond (e.g., crosslinking by carbon black in elastomers) or filling of a certain volume and disruption of the conformational position of a polymer matrix, and also the immobilization of adjacent molecule groups and possible orientation of the polymer material (Gächter/Müller, Taschenbuch der Kunststoff-Additive, Carl Hanser Verlag, Munich/Vienna, 1979).

Customary fillers have sizes in the μm (micrometer) range, with just a few, such as glass nanoparticles and nanowhiskers, for example, being smaller than this, with a diameter of 250 nm (nanometers) or 350 nm (Saechtling, Kunststoffaschenbuch, 28th Edition, Carl Hanser Verlag, 2001). Although the literature includes the amorphous silica marketed by Degussa AG under the name Aerosil® with a primary particle size of 7 to 20 nm, its primary particles are nevertheless not isolated but instead form aggregates from which, in turn, larger agglomerates are formed (Degussa-Hüls product information, PT 155.0/1/01/.2000).

Nanoscale fillers or nanofillers, with primary particles of about 50 nm or below (Polymer News 24 (1999), 331-341), are contained in particular within the (organic/inorganic) nano-composites which have appeared variously on the market in recent times. Owing to the low particle size of the filler and the extremely high surface areas, particular mechanical properties are developed, which give the corresponding nanocomposites high load-bearing capacity. For example, nature employs nanofillers of this kind in bone, sinew, and dental material.

Because of these special mechanical properties the importance of organic/inorganic nanocomposites is on the increase.

The polyhedral oligomeric silasesequioxanes which have been disclosed in the literature likewise possess primary particle sizes of 1 to 3 nm (product information Hybrid Plastics 2000, www.hybridplastics.com), but these particles are not present in the solid state but instead generally form the much larger agglomerates. Even in the dissolved state the aggregates present are said to be about 30 to 50 nm in size. Although micronizing apparatus such as a jet mill, for example, can be used to grind the agglomerates which occur in the solid state, the resulting particle size is still in the μm range, and no nanoscale particles are present. The reasons for this are, in particular, physical. No milling equipment is able to grind to significantly below 1 μm, since below a certain fineness the disruption rate and recombination rate of the particles are in equilibrium.

The object was to develop a synthesis for nanofillers having primary particles sizes of less than 20 nm (nanometers) with the particular feature that this primary particle size should be retained in a polymer matrix or that the formation of aggregates and agglomerates should be prevented.

Surprisingly it has been possible to achieve this object by using as nanofillers polyhedral oligomeric silicon-oxygen clusters which possess a maximum of four but preferably only one reactive site which can be brought to reaction with a matrix so that the polyhedral oligomeric silicon-oxygen clusters are present in a molecular structure with a particle size of less than 20 nm.

By polyhedral oligomeric silicon-oxygen clusters are meant, preferably, the two classes of compound represented by the silasesquioxanes and the spherosilicates.

Silasesquioxanes are oligomeric or polymeric substances whose fully condensed representatives possess the general formula (SiO_{3/2}R)ₙ, in which n≧4 and the radical R can be a hydrogen atom but is usually an organic radical. The smallest structure of a silasesquioxane is the tetrahedron. Voronkov and Lavrent'yev (Top. Curr. Chem. 102 (1982), 199-236) describe the synthesis of fully condensed and incompletely condensed oligomeric silasesquioxanes by hydrolytic condensation of triflnctional RSiY₃ precursors, where R stands for a hydrocarbon radical and Y is a hydrolyzable group, such as chloride, alkoxide or siloxide. Lichtenhan et al. describe the base-catalyzed preparation of oligomeric silasesquioxanes (WO 01/10871). Silasesquioxanes of the formula R₈Si₈O₁₂ (with identical or different hydrocarbon radicals R) can be reacted under base catalysis to functionalized, incompletely condensed silasesquioxanes, such as R₇Si₇O₉(OH)₃, for example, or else R₈Si₈O₁₁(OH)₂ and R₈Si₈₁₀(OH)₄ (Chem. Commun. (1999), 2309-10; Polym. Mater. Sci. Eng. 82 (2000), 301-2; WO 01/10871) and thus can serve as parent compound for a host of different incompletely condensed and functionalized silasesquioxanes. The silasesquioxanes (trisilanols) of the formula R₇Si₇O₉(OH)₃ in particular can be converted into correspondingly modified oligomeric silasesquioxanes by reaction with functionalized monomeric silanes (comer capping).

Oligomeric spherosilicates have a construction similar to that of the oligomeric silasesquioxanes. They too possess a “cagelike” structure. Unlike the silasesquioxanes, owing to the method by which they are prepared, the silicon atoms at the comers of a spherosilicate are connected to a further oxygen atom, which in turn is further substituted. Oligomeric spherosilicates can be prepared by silylating suitable silicate precursors (D. Hoebbel, W. Wieker, Z. Anorg. Allg. Chem. 384 (1971), 43-52; P.A. Agaskar, Colloids Surf. 63 (1992), 131-8; P.G. Harrison, R. Kannengiesser, C. J. Hall, J. Main Group Met. Chem. 20 (1997), 137-141; R. Weidner, Zeller, B. Deubzer, V. Frey, Ger. Offen. (1990), DE 38 37 397). For example, the spherosilicate with the structure 3 can be synthesized from the silicate precursor of the structure 2, which in turn is obtainable by the reaction of Si(OEt)₄ with choline silicate or by the reaction of waste products from the harvesting of rice with tetramethylammonium hydroxide (R. M. Laine, I. Hasegawa, C; Brick, J. Kampf, Abstracts of Papers, 222^{nd} ACS National Meeting, Chicago, Ill., United States, Aug. 26-30, 2001, MTLS-018).

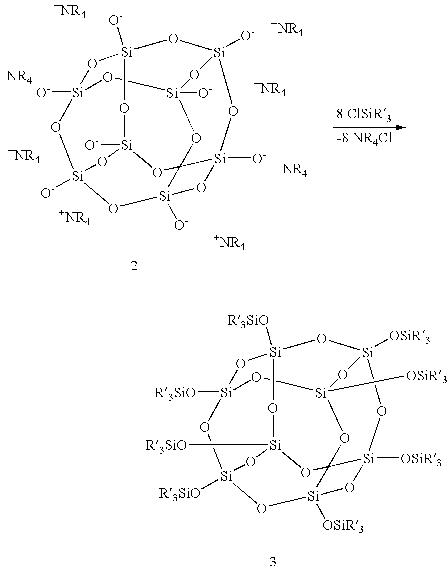

Both the silasesquioxanes and the spherosilicates are thermally stable at temperatures of up to several hundred degrees Celsius.

The present invention accordingly provides a nanofiller, preferably for matrix materials, as claimed in claim 1, the nanofiller having a (particle) size of less than 20 nm and comprising functionalized polyhedral oligomeric silicon-oxygen cluster units of the formula
[(RₐX_{b}SO_{1.5})ₘ (R_{c}X_{d}SiO)ₙ (RₑX_{f}Si₂O_{2.5})ₒ (R_{g}XₕSi₂O₂)ₚ]
with:
a, b, c=0-1; d=1-2; e, g, f=0-3; h=1-4;
m·b+n·d+o·f+p·h≦4; m+n+o+p≧4; a+b=1; c+d=2; e+f=3 and g+h=4;
R=hydrogen atom, alkyl, cycloalkyl, alkenyl, cycloalkenyl, alkynyl, cycloalkynyl, aryl, heteroaryl group or polymer unit, which are in each case substituted or unsubstituted, or further functionalized polyhedral oligomeric silicon-oxygen cluster units, which are attached by way of a polymer unit or a bridging unit,
X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R containing at least one such group of the type X,
   the substituents of the type R being identical or different and the substituents of the type X being identical or different, with the proviso that there are not more than four substituents or groups of the type X per cluster unit.

Likewise provided by the present invention is a matrix which comprises a nanofiller of the invention and further comprises a nanofiller of the invention bonded covalently to the matrix material by a chemical reaction, and also provides a process for preparing such a matrix, which comprises mixing the nanofiller of the invention into a matrix material which is in liquid form and forming by means of a chemical reaction at least one covalent bond between nanofiller of the invention and matrix material.

The present invention additionally provides for the use of a nanofiller of the invention for producing plastics, sealing compounds, paints, printing inks, adhesives, ceramics, mineral building materials, concrete, mortar, plaster, and coatings of ceramics and plastics.

The nanofiller of the invention possesses per molecule or cluster unit not more than four, preferably two, more preferably just one reactive group which can be brought to reaction with a matrix material. As a result the nanofiller, i.e., the filler molecule, is attached covalently to the matrix material, and is therefore present in the form of an unagglomerated or unaggregated nanofiller. The reactive group may preferably be an amino, hydroxyl, carboxyl, isocyanate, epoxy, alkoxysilyl, siloxy, alkylsiloxy, alkoxysiloxy, alkoxysilylalkyl or vinylic group.

For the formation of the covalent bond between inventive nanofiller and matrix there are a variety of appropriate chemical reactions and reaction mechanisms, such as
esterification (hydroxyl group plus carboxylic acid or carboxylic acid derivative group),
hydrosilylation (addition of an SiH group onto alkanes or alkenes),
urethane formation (hydroxyl group plus isocyanate group),
urea formation (amino group plus isocyanate group),
amino alcohol formation (epoxy group plus amino group),
formation of hydroxy ethers (epoxy group plus alcohol) or
copolymerization or grafting via the double bond.

The nanofiller of the invention has the advantage that materials based on one or more organic matrix materials can be obtained which have increased mechanical stability and mechanical strength, improved solvent resistance, improved barrier behavior, increased adhesion, higher temperature stability, lower electroconductivity and also enhanced abrasion resistance and scratch resistance of the matrix surface. Moreover, the elasticity of inorganic materials can be raised by using chemical compounds comprising functionalized polyhedral oligomeric silicon-oxygen cluster units. In contrast to many conventional nanofillers, the characteristics of the nanofiller of the invention can be controlled by way of the substituents of these polyhedral oligomeric silicon-oxygen cluster units and thus it is also possible to influence the properties of the resultant matrix.

A feature of the nanofiller of the invention is that it has a (particle) size of less than 20 nm and comprises functionalized polyhedral oligomeric silicon-oxygen cluster units of the formula
[(RₐX_{b}SiO_{1.5})ₘ (R_{c}X_{d}SiO)ₙ(RₑX_{f}Si₂O_{2.5})ₒ (R_{g}XₕSi₂O₂)ₚ]
with:
a, b, c=0-1; d=1-2; e, g, f=0-3; h=1-4;
m·b+n·d+o·f+p·h≦4; m+n+o+p≧4; a+b=1; c+d=2; e+f=3 and g+h=4;
R=hydrogen atom, alkyl, cycloalkyl, alkenyl, cycloalkenyl, alkynyl, cycloalkynyl, aryl, heteroaryl group or polymer unit, which are in each case substituted or unsubstituted, or further functionalized polyhedral oligomeric. silicon-oxygen cluster units, which are attached by way of a polymer unit or a bridging unit,
X=oxy, hydroxyl, alkoxy, carboxyl, silyl, alkylsilyl, alkoxysilyl, siloxy, alkylsiloxy, alkoxy-siloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R containing at least one such group of the type X,
the substituents of the type R being identical or different and the substituents of the type X being identical or different, with the proviso that there are not more than four substituents of the type X per cluster unit.

It can be advantageous if the nanofiller comprises a functionalized polyhedral oligomeric silicon-oxygen cluster unit based on the structure 1 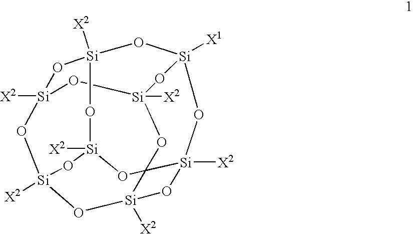
with X¹=substituent of type X or of type —O—SiX₃, X²=substituent of type X, —O—SiX₃, —O—SiX₂R, R, —O—SiXR₂ or —O—SiR₃, with the proviso that there are not more than four groups of the type X per cluster unit.

Preferred nanofillers are those based on functionalized polyhedral oligomeric silicon-oxygen cluster units of structure 4, 5 or 6, 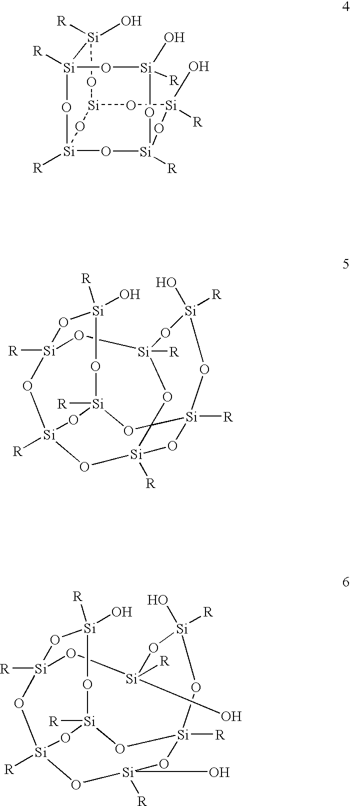
R=hydrogen atom, alkyl, cycloalkyl, alkenyl, cycloalkenyl, alkynyl, cycloalkynyl, aryl, heteroaryl group or polymer unit, which are in each case substituted or unsubstituted, or further functionalized oligomeric silasesquioxane units which are attached by way of a polymer unit or a bridging unit,
   in accordance with the invention the resulting silicon-oxygen cluster unit necessarily containing not more than four hydroxyl groups or other reactive groups.

With particular preference the nanofiller of the invention comprises functionalized polyhedral oligomeric silicon-oxygen cluster units of the formula
[(RₐX_{b}SiO_{1.5})ₘ (R_{c}X_{d}SiO)ₙ (RₑX_{f}Si₂O_{2.5})ₒ (R_{g}XhSi₂O₂)ₚ]
with:
a, b, c=0-1; d=1-2; e, g=0-3; f=0-2; h=1-2;
m·b+n·d+o·f+p·h≦2; m+n+o+p≧4; a+b=1; c+d=2; e+f=3 and g+h=4;
R=hydrogen atom, alkyl, cycloalkyl, alkenyl, cycloalkenyl, alkynyl, cycloalkynyl, aryl, heteroaryl group or polymer unit, which are in each case substituted or unsubstituted or further functionalized polyhedral oligomeric silicon-oxygen cluster units, which are attached by way of a polymer unit or a bridging unit,
X=oxy, hydroxyl, alkoxy, carboxyl, silyl, alkylsilyl, alkoxysilyl, siloxy, alkylsiloxy, alkoxy-siloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R containing at least one such group of the type X,
   the substituents of the type R being identical or different and the substituents of the type X being identical or different, with the proviso that there are not more than two substituents of the type X per cluster unit.

The nanofiller of the invention preferably has a (particle) size of less than 10 nm, more preferably less than 6 nm. The nanofiller of the invention is able to enter into at least one chemical bond with a matrix or matrix material. Where the cluster unit of the nanofiller of the invention contains two, three or four substituents or groups of the type X, they may be identical or different. The substituents or groups of the type X are preferably different. When using different groups of the type X it is possible to exploit different reaction rates or else to incorporate the nanofillers of the invention in a targeted way between two components of a matrix material each having groups which in each case form a bond only with one of the different groups of the type X of the nanofiller of the invention. Where the matrix material is composed, for example, of a blend of two different polymers (type A and type B), the nanofiller of the invention may react specifically, with one of its groups of the type X, with the polymer of type A and, with the other groups of type X, with the polymer of type B.

The substituents of type X of the functionalized polyhedral oligomeric silicon-oxygen cluster units contain preferably double bonds, i.e., vinylic groups, isocyanate groups, blocked isocyanate groups, amino, especially primary or secondary amino, acrylate, methacrylate, carboxyl, alkoxysilyl, siloxy, alkylsiloxy, alkoxysiloxy, alkoxysilylalkyl, hydroxyl and/or epoxy group radicals. The polyhedral oligomeric silicon-oxygen cluster units of the nanofiller of the invention are functionalized by way of the substituents of type X. For certain fields of application, such as in the case of coating materials, for example, it is possible to use nanofillers having blocked or capped isocyanate groups. In the case of the nanofiller of the invention, this functionality can be controlled through the choice of the substituents of type X. For the field of use of coating materials it is possible with preference to use nanofillers of the invention containing polyhedral oligomeric silicon-oxygen cluster units with blocked or capped isocyanate groups as substituents of type X. This nanofiller of the invention can be prepared, for example, by way of a ring formation, in which two isocyanate molecules form a uretdione or three isocyanate molecules form an isocyanurate, or by a blocking procedure, with caprolactam, phenols or malonic acid, for example.

In one particular embodiment of the nanofiller of the invention the nanofiller possesses per cluster unit not more than one substituent of the type X; in one particularly preferred embodiment of the nanofiller said one substituent of the type X is an alkoxysilyl, siloxy, alkylsiloxy, alkoxysiloxy, alkoxysilylalkyl, amino, hydroxyl, isocyanate, epoxy or vinylic group.

On the basis of their molecular character, the nanofillers of the invention possess a uniform and defined molecular weight. In one particular embodiment of the nanofiller of the invention it has a molecular weight of preferably at least 400 g/mol, more preferably from 400 to 2500 g/mol, and with particular preference from 400 to 600 g/mol. The molecular size of the nanofiller of the invention can be increased by joining two or more polyhedral oligomeric silicon-oxygen cluster units, each functionalized with two reactive groups of type X, by means of condensation: for example, via a spacer and/or the functional groups of the substituents of type X. Additionally, an enlargement of the nanofiller of the invention can be achieved by means of homopolymerization or copolymerization.

The polyhedral oligomeric silicon-oxygen cluster units may in particular be from the class of the spherosilicates of the formula
[(RₑX_{f}Si₂O_{2.5})ₒ (R_{g}XₕSi₂O₂)_{p]}
with:
e.g.=0-3; f=0-2; h=1-2; o+p≧4; e+f=3; g+h=4;
   and with the proviso that the spherosilicates contain not more than two groups or substituents of the type X. Preferably, therefore, the functionalized polyhedral oligomeric silicon-oxygen cluster unit is a functionalized oligomeric spherosilicate unit.

Preferably, however, the polyhedral oligomeric silicon-oxygen cluster units are from the class of the silasesquioxanes of the formula
[(RₐX_{b}SiO_{1.5})ₘ (R_{c}X_{d}SiO)ₙ]
with:
a, b, c=0-1; d=1-2; m+n≧4; a+b=1; c+d=2
   and with the proviso that the silasesquioxanes contain not more than two groups or substituents of the type X. Preferably, therefore, the functionalized polyhedral oligomeric silicon-oxygen cluster unit is a functionalized oligomeric silasesquioxane unit. The substituents of type R of the silasesquioxane units may all be identical, producing what is termed a functionalized homoleptic structure
   [(RSiO_{1.5})ₘ (RXSiO)ₙ]
   with:
m+n=z and z≧4, z corresponding to the number of silicon atoms in the framework structure of the polyhedral oligomeric silicon-oxygen cluster unit;
R=hydrogen atom, alkyl, cycloalkyl, alkenyl, cycloalkenyl, alkynyl, cycloalkynyl, aryl, heteroaryl group or polymer unit, which are in each case substituted or unsubstituted, or further functionalized polyhedral oligomeric silicon-oxygen cluster units, which are attached by way of a polymer unit or a bridging unit,
X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R containing at least one such group of the type X,
   the substituents of the type R being identical or different and the substituents of the type X being identical or different, there being again not more than two substituents or groups of the type X in the silasesquioxane unit.

In a further embodiment of the nanofiller of the invention it is possible for at least two of the substituents of the type R to be different, in which case the nanofiller is said to have a functionalized heteroleptic structure
[(RSiO_{1.5})ₘ (R′XSiO)ₙ]
with:
m+n=z and z≧4, z corresponding to the number of silicon atoms in the framework structure of the polyhedral oligomeric silicon-oxygen cluster unit;
R=hydrogen atom, alkyl, cycloalkyl, alkenyl, cycloalkenyl, alkynyl, cycloalkynyl, aryl, heteroaryl group or polymer unit, which are in each case substituted or unsubstituted, or further functionalized polyhedral oligomeric silicon-oxygen cluster units, which are attached by way of a polymer unit or a bridging unit,
X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R containing at least one such group of the type X,
   the substituents of the type R being identical or different and the substituents of the type X being identical or different, there being again not more than two substituents or groups of the type X in the silasesquioxane unit.

The nanofillers of the invention which comprise functionalized oligomeric silasesquioxane units can be obtained by reacting silasesquioxanes having free hydroxyl groups with monomeric functionalized silanes of structure Y₃Si—X³, Y₂SiX³X⁴, and YsiX³X⁴X⁵, the substituent Y being a leaving group selected from alkoxy, carboxyl, halogen, silyloxy or amino group, the substituents X³, X⁴, and X⁵ being of the type X or R and being identical or different, where X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of type R containing at least one such group of the type X, and R=hydrogen atom, alkyl, cycloalkyl, alkenyl, cycloalkenyl, alkynyl, cycloalkynyl, aryl, heteroaryl group or polymer unit, which are in each case substituted or unsubstituted or further functionalized oligomeric silasesquioxane units which are attached by way of a polymer unit or a bridging unit, with the proviso that for each silasesquioxane unit obtained there are not more than one or two substituents of the type X per cluster unit.

It can be especially advantageous if the nanofiller of the invention contains per cluster unit not more than one substituent of the type X or one group of the type X. In particular it is possible in this way to prevent instances of crosslinking between the nanofillers or between the nanofillers and the matrix materials.

By means of the nanofillers of the invention it is possible to obtain matrices which of their type were not hitherto available. The general feature of a matrix of the invention is that it comprises the nanofiller of the invention. The matrix of the invention preferably comprises a nanofiller of the invention bonded covalently by a chemical reaction to the organic and/or inorganic matrix material. The matrix contains preferably from 0.05 to 90% by weight, more preferably from 0.1 to 50% by weight, of the nanofiller of the invention, with particular preference from 0.2 to 30% by weight, and with very particular preference from 0.5 to 15% by weight of the nanofiller of the invention. Preference may also be given to a matrix comprising a combination of different nanofillers including at least one nanofiller of the invention. Where a combination of nanofillers is used the matrix material has an added amount of the nanofiller of the invention, based on the matrix material, of preferably from 0.01 to 25% by weight, more preferably from 0.05 to 20% by weight, and with particular preference from 0.3 to 12% by weight. It is, however, also possible for the surface of a matrix to comprise exclusively the nanofiller of the invention.

The matrix of the invention may comprise organic and/or inorganic matrix materials. The inorganic matrix material of the matrix of the invention comprises preferably mineral building materials and/or inorganic sinter compositions. As organic matrix material the matrix of the invention may comprise an elastomer, thermoplastic or thermoset. With particular preference this matrix comprises as organic matrix material a plastic or polymer selected from polyethylene, polypropylene, polyester, copolyester, polycarbonate, polyamide, copolyamide, polyurethane, polyacrylate, polymethacrylate, polymethacrylate copolymer, polysiloxane, polysilane, polytetrafluoroethylene, phenolic resin, polyoxymethylene, epoxy resin, polyvinyl chloride, vinyl chloride copolymer, polystyrene, styrene copolymers, ABS polymer, alkyd resin, unsaturated polyester resin, nitrocellulose resin or rubber.

One particular embodiment of the matrix of the invention comprises an organic matrix selected from polyesters, polyamides, copolyamides, polyetheramides, polyurethane systems, hydrocarbon resins, polyamide resins, alkyd resins, maleate resins, polyacrylates, urea resins, polyterpene resins, ketone-aldehyde resins, epoxy resins, phenolic resins, polyester resins, and cellulose derivatives, resins based on rosin, shellac and dammar, and all derivatives derived from the aforementioned resins. Such a matrix is suitable with preference for the preparation of paint systems and printing ink systems, with particular preference though for the preparation of powder coating materials.

The use of nanofillers of the invention comprising functionalized polyhedral oligomeric silicon-oxygen cluster units in organic matrix materials results in an increase not only in the mechanical stability and strength of the resultant materials but also in the thermal stability and electrical resistance. Moreover, the elasticity of inorganic materials can be raised through the use of chemical compounds comprising functionalized polyhedral oligomeric silicon-oxygen cluster units as nanofillers. In contrast to many conventional nanofillers, the characteristics of the nanofiller of the invention can be controlled by way of the substituents of the functionalized polyhedral oligomeric silicon-oxygen cluster units and so the properties of the resultant material can also be influenced. Accordingly, it is possible to predetermine the physical and chemical properties of the nanofiller of the invention. The polarity of the nanofiller of the invention can be adjusted by way of the substituents of the type R and X on the polyhedral oligomeric silicon-oxygen cluster units. By way of the different structure and polarity of these substituents it is possible to control whether the polyhedral oligomeric silicon-oxygen cluster units are more inorganic or more organic in nature. Depending on structure, the nanofillers of the invention may be of high thermal stability. As a result of the cage structure of the polyhedral oligomeric silicon-oxygen cluster units only a few functional groups are necessary for attachment of the nanofiller molecules, since with one functionalized group it is possible to attach an entire “cage”.

In one particular embodiment of the matrix of the invention the nanofiller of the invention forms preferably only one covalent bond to the matrix material. For this purpose it is necessary for the reactive substituents of type X of the nanofiller of the invention and the reactive functional groups in the matrix material to be matched to one another. For instance, both the matrix material and the nanofiller of the invention may comprise double bonds, hydroxyl, carboxyl, amino, isocyanate, epoxy, alkoxysilyl, siloxy, alkylsiloxy, alkoxysiloxy or alkoxysilylalkyl groups. By radiation, temperature, addition of moisture or addition of initiator the reaction between the matrix material and the nanofiller of the invention is initiated, and so covalent bonds are formed. The radiation used for the process may comprise electron beams, UV radiation or microwaves.

The matrix of the invention, especially organic matrix materials, is preferably prepared by means of the process of the invention, which comprises mixing the nanofiller of the invention into a matrix material which is in liquid form and by chemical reaction forming at least one covalent bond between nanofiller and matrix material. The covalent bond may be formed, for example, by one of the following chemical reactions, for example:
esterification (hydroxyl group plus carboxylic acid or carboxylic acid derivative group),
hydrosilylation (addition of an SiH group onto alkanes or alkenes),
urethane formation (hydroxyl group plus isocyanate group),
urea formation (amino group plus isocyanate group),
amino alcohol formation (epoxy group plus amino group),
formation of hydroxy ethers (epoxy group plus alcohol) or
copolymerization or grafting via the double bond.

The matrix material which is in liquid form can be present either as a melt or as a solution. Solvents which can be used for polymeric matrix materials include, in particular, organic solvent systems, such as aliphatics, aromatics, cycloaliphatics, keto compounds, ethers, and esters. The aforementioned solvents may be either substituted or unsubstituted. The nanofillers are normally mixed in using stirring and mixing equipment of any kind. It can be especially advantageous if before being mixed into the matrix material the nanofiller is likewise dissolved in a solvent. In this way a uniform distribution of the nanofillers in the matrix material is achieved. Particular preference is given to an organic solvent system in which both the matrix material and the nanofiller are soluble.

As stated, reaction with a melted matrix material is also possible. In this case the nanofiller is mixed in by being added mechanically en masse to a polymer melt and so reacted with the polymer matrix. Particularly suitable apparatus includes extruders, kneading devices, and mixers. In such apparatus the mechanical action causes at least partial, incipient melting of the matrix material, so that the nanofiller can be mixed into these liquid portions of the matrix material.

The nanofillers of the invention can be used in particular for producing plastics, sealing compounds, paints, printing inks, adhesives, ceramics, mineral building materials, concrete, mortar, plaster, and coatings of ceramics and plastics.

The nanofiller of the invention can be used in particular for an inorganic matrix for producing ceramics, concrete, mortar, plaster and/or mineral building materials. The nanofiller of the invention is also suitable for producing plastics, paints, inks, such as printing inks, for example, adhesives, sealing compounds, casting compounds, filling compounds, spreading compounds, foams, and coatings, which can be used both with organic materials and with inorganic or metallic materials.

When the nanofiller of the invention with alkoxysilyl-, siloxy-, alkylsiloxy-, alkoxysiloxy- or alkoxysilylalkyl-functionalized polyhedral oligomeric silicon-oxygen cluster units is introduced into mineral substances, such as into plasters, for example, the nanofiller of the invention preferably contains a group which is capable of adhesion to mineral substances, which is able to react, for example, with the hydroxyl groups of the mineral substance.

This particular embodiment of the nanofiller of the invention, with alkoxysilyl-, siloxy-, alkylsiloxy-, alkoxysiloxy- or alkoxysilylalkyl-functionalized polyhedral oligomeric silicon-oxygen cluster units, can be used as a nanofiller for the coating of mineral building materials. This nanofiller reacts with the hydroxyl groups of the building material, thereby producing good adhesion of the coating to the building material. The nanofiller of the invention can also be used for coatings of ceramics.

Polymers modified with preference with the nanofiller of the invention are polymers containing hydroxyl and carboxyl groups, primary or secondary amino groups, and also rubbers and all kinds of polymers having double bonds.

Accordingly the nanofiller of the invention contains at least one isocyanate, blocked isocyanate, epoxy, alkoxysilyl, siloxy, alkylsiloxy, alkoxysiloxy or alkoxysilylalkyl group or one vinylic double bond.

It is, however, also possible to precede in reverse. In other words, the polymer contains isocyanate, blocked isocyanate, epoxy, alkoxysilyl, siloxy, alkylsiloxy, alkoxysiloxy or alkoxysilylalkyl groups or vinylic double bonds while the nanofiller of the invention contains at least one hydroxyl, carboxyl or primary or secondary amino group or one double bond.

The examples which follow are intended to illustrate the invention without restricting the scope of its protection:

### EXAMPLE 1

### Preparation of the Precursor of Some Inventive Nanofillers

### 1.1 Synthesis of (isobutyl)₈Si₈O₁₂ from isobutyltrimethoxysilane

To a solution of 446 g (2.5 mol) of isobutyltrimethoxysilane ((isobutyl)Si(OMe)₃, DYNASYLAN® IBTMO, Degussa AG) in 4300 ml of acetone there is added with stirring a solution of 6.4 g (0.11 mol) of KOH in 200 ml of H₂O. The reaction mixture is subsequently stirred at 30° C. for 3 days. The precipitate formed is filtered off and dried under reduced pressure at 70° C. The product (isobutyl)₈Si₈O₁₂ is obtained in a yield of 262 g (96%).

### 1.2 Synthesis of (isobutyl)₇Si₇O₉(OH)₃ from (isobutyl)₈Si₈O₁₂

At a temperature of 55° C. 55 g (63 mmol) of (isobutyl)₈Si₈O₁₂ are introduced into 500 ml of an acetone/methanol mixture (volume ratio 84:16) which contains 5.0 ml (278 mmol) of H₂O and 10.0 g (437 mmol) of LiOH. The reaction mixture was subsequently stirred at 55° C. for 18 h and then introduced into 500 ml of IN hydrochloric acid. After stirring for 5 minutes the solid obtained is filtered off and washed with 100 ml of CH₃OH. Drying in air gives 54.8 g (96%) of (isobutyl)₇Si₇O₉(OH)₃.

### EXAMPLE 2

### Preparation of Inventive Nanofillers

### 2.1 Synthesis of (3-methacryloyloxypropyl)(isobutyl)₇Si₈O₁₂ from (isobutyl)₇Si₇O₉(OH)₃ and 3-methacryloyloxypropyltrimethoxysilane

To a solution of 50 g (63 mmol) of (isobutyl)₇Si₇O₉(OH)₃ (preparation described in Example 1) in 50 ml of THF there are added at 20° C. 16 g (64.4 mmol) of 3-methacryloyloxypropyltrimethoxysilane (DYNASYLAN® MEMO, Degussa A G). Following addition of 2.5 ml of an aqueous tetraethylammonium hydroxide solution (35% by weight) the mixture is stirred overnight. Removal of about 15 ml of THF results in a white suspension. By adding 250 ml of methanol the product is precipitated further. After filtration, the solid which remains is washed with methanol. Drying gives 38 g of (3-methacryloyloxypropyl)(isobutyl)₇Si₈O₁₂ (70% yield) as a white powder which can be used as a nanofiller.

### 2.2 Synthesis of (3-aminopropyl)(isobutyl)₇Si8O₁₂ from (isobutyl)₇Si₇O₉(OH)₃ and 3-aminopropyltriethoxysilane

To a solution of 20 g (25.3 mmol) of (isobutyl)₇Si₇O₉(OH)₃ (preparation described in Example 1) in 20 ml of THF were added at 20° C. 4.67 g (26 mmol) of 3-aminopropyltriethoxysilane (DYNASYLAN® AMEO, Degussa AG). The mixture is then stirred overnight. The reaction solution is subsequently admixed with 100 ml of methanol over 3 minutes. Filtration, washing of the precipitate with methanol, and subsequent drying of the precipitate gives 17 g of (3-aminopropyl)(isobutyl)₇Si₈O₁₂ (77% yield) as a white powder which can be used as a nanofiller.

### 2.3 Synthesis of (3-glycidyloxypropyl)(isobutyl)7Si₈O₁₂ from (isobutyl)₇Si₇O₉(OH)₃ and (3-glycidyloxypropyl)trimethoxysilane

To a solution of 50 g (63 mmol) of (isobutyl)₇Si₇O₉(OH)₃ (preparation described in Example 1) in 50 ml of THF were added at 20° C. 15.2 g (64.3 mmol) of (3-glycidyloxypropyl)-trimethoxysilane (DYNASYLAN® GLYMO, Degussa AG). Following addition of 2.5 ml of an aqueous tetraethylammonium hydroxide solution (35% by weight) the mixture is stirred overnight. Removal of about 15 ml of THF results in a white suspension. By slow addition of 250 ml of methanol over the course of 30 minutes the product is precipitated further. After filtration, the solid which remains is washed with methanol. Drying gives 46 g of (3-glycidyloxypropyl)(isobutyl)₇Si₈O₁₂ (78% yield) as a white powder which can be used as a nanofiller.

### EXAMPLE 3

### Preparation of an Inventive Matrix, Testing, and Properties

### 3.1 Inventive Nanofiller in a Polyamide 12 or Polybutylene Terephthalate Matrix

3.1.1 Preparation

Polyamide 12 (VESTAMID® L 1700, Degussa AG) or polybutylene terephthalate (VESTODUR® 1000, Degussa AG) is first of all premixed with the inventive nanofiller, (prepared according to Example 2.2 or 2.3) in a commercially customary mixing drum and this mixture is then precompounded on a laboratory extruder from DSM in an amount of 100 g at a temperature of 235° C. The amount of the inventive nanofiller added in this case is between 10% by weight and 30% by weight based on the matrix. After the extrudates have been pelletized the resulting pellets—together where appropriate with further, unmodified matrix material, so as to give a nanofiller content of less than 10% by weight in the matrix material—are extruded a second time in an amount totaling 2000 g in a mini-twin-extruder from Haake (Rheomex R 302). Sample specimens are then injection molded at a temperature of 240° C. on an apparatus from Dr. Boy (type 22M).

3.1.2 Properties

| | | | | | | |
|---|---|---|---|---|---|---|
| | | | | | | Vicate |
| | | | | | | softening |
| | | | | | Tensile | temperature |
| | | Added | | | modulus | 50° C./h 50 N |
| | Nanofiller | amount of | | | (N/mm²) | (° C.) |
| | prepared as in | nanofiller | | | to | to |
| Experiment | Example . . . | (% by weight) | Inventive | Not inventive | DIN ISO R 527 | DIN ISO 306 |

Polyamide 12

| | | | | | | |
|---|---|---|---|---|---|---|
| 3.1.1 | 2.2 | 3 | X | | 2800 | 150 |
| 3.1.2 | 2.3 | 10 | X | | 4700 | 165 |
| 3.1.3 | | — | | X | 1400 | 140 |

Polybutylene terephthalate

| | | | | | | |
|---|---|---|---|---|---|---|
| 3.1.4 | 2.3 | 2 | X | | 3700 | 185 |
| 3.1.5 | 2.3 | 12 | X | | 4500 | 190 |
| 3.1.6 | | — | | X | 2600 | 180 |

It is apparent that by using the inventive nanofiller it is possible to raise the tensile modulus and also to bring about marked improvements in the softening temperature and thermal stability.

### 3.2 Inventive Nanofiller in a Copolyester Matrix

3.2.1 Preparation

The copolyesters DYNAPOL® S 1510, Degussa AG and DYNACOLL® 7360, Degussa AG are each compounded in an oil-heated laboratory kneading apparatus from Meili at a temperature of 220° C. (DYNAPOL®) or 130° C. (DYNACOLL®) under a nitrogen atmosphere to give the corresponding mixtures. In the case of DYNACOLL® the preparation is carried out in the absence of moisture.

3.2.2 Testing

Setting Time

To measure the setting time, the inventive or noninventive matrix is thinly applied from the hot melt, which is at 200° C. (DYNAPOL®) or 120° C. (DYNACOLL®), to a 25×25 mm wooden block and immediately thereafter this block is joined or adhesively bonded with a second wooden block of the same base area. The setting time indicates how long the pieces of wood can still be displaced relative to one another by means of strong finger pressure. The lower the period of time, the more favorable the setting behavior of the hotmelt adhesive. The results are shown in the table in 3.2.3.

Bonding Experiments

Inventive or noninventive matrix is applied following its preparation to a stainless steel test element at a temperature of 200° C. (DYNAPOL®) or 120° C. (DYNACOLL®). Within 0.5 minute this test element is joined over an area of 4 cm² to a further stainless steel test element, with a simple overlap, and the elements are pressed against one another with a weight of 2 kg for 5 minutes. The bonded specimen is then stored at 23° C. and 60% relative humidity for 14 days, after which a tensile test and a thermal stability test are conducted. The results are given in the table in 3.2.3.

Properties

| | | | | | | | |
|---|---|---|---|---|---|---|---|
| | | Added | | | | | |
| | | amount | | | | | |
| | Nanofiller | of | | | | Thermal stability | Tensile shear |
| | prepared as | nanofiller | | | | (° C.) | strength(N/mm²) |
| Experiment | in Example . . . | (% by weight) | Inventive | Noninventive | Setting time(s) | after 68 WPS | to DIN 53 283 |

DYNAPOL ® copolyester

| | | | | | | | |
|---|---|---|---|---|---|---|---|
| 3.2.1 | 2.3 | 6 | X | | n.d.* | 144 | 1.8 |
| 3.2.2 | | — | | X | n.d.* | 127 | 1.4 |

DYNACOLL ® + 6.6% by weight
4,4′-methylenedi(phenyl isocyanate) (MDI)
copolyester

| | | | | | | | |
|---|---|---|---|---|---|---|---|
| 3.2.3 | 2.2 | 5 | X | | 8 | 253 | 3.0 |
| 3.2.4 | | — | | X | 18 | 206 | 2.3 |

*not determined

It is apparent that by using the nanofiller of the invention there is a shortening of the setting time, and it is also possible to bring about marked improvements in the tensile shear strength and thermal stability.

### 3.3 Inventive Nanofiller in a Polymethyl Methacrylate Matrix

3.3.1 Preparation

The inventive nanofiller (prepared as in Example 2.1) can be incorporated into polymers, such as polyolefins, polyacrylates or polymethyl methacrylates (PMMA), for example, by copolymerization or subsequent grafting. Accordingly, pure methyl methacrylate (MMA) or MMA with dissolved nanofiller (prepared as in Example 2.1)—with 0.2% by weight of benzoyl peroxide—is polymerized in a test tube in a water bath at a temperature of 45° C. for 17 hours. After the reaction the test tube is broken and the specimen is isolated and heated at a temperature of 100° C. for 6 hours more.

3.3.2 Testing for Scratch Resistance

The specimens from 3.3.1 are loaded at a temperature of 25° C. with a commercially customary steel wool pad with a steel weight of 100 g. The pad is then rubbed backward and forward 50 times, after which the surface is assessed visually (assessments 1 to 5, 1 being very good and 5 being failure).

3.3.3 Properties

| | | Added amount | | | |
|---|---|---|---|---|---|
| | Nanofiller | of | | | |
| | prepared as in | nanofiller | | | Scratch resistance |
| Experiment | Example . . . | (% by weight) | Inventive | Not inventive | (visual assessment) |
| 3.3.1 | 2.1 | 8 | X | | 2 |
| 3.3.2 | | — | | X | 5 |

The scratch resistance can be increased markedly by copolymerization of the inventive nanofiller.

1-29. (canceled)

30. A matrix comprising a nanofiller,
which comprises a nanofiller bonded covalently by a chemical reaction to an organic and/or inorganic matrix material, the nanofiller having a size of less than 20 nm and comprising functionalized polyhedral oligomeric silicon-oxygen cluster units of the formula
[(RₐX_{b}SiO_{1.5})ₘ (R_{c}X_{d}SiO)ₙ (RₑX_{f}Si₂O_{2.5})ₒ(R_{g}XₕSi₂O₂)ₐ]
with:
a, b, c=0-1; d=1-2; e, g, f=0-3; h=1-4;
m·b +n·d+o·f+p·h≦4; m+n+o+p≧4; a+b =1; c+d=2; e+f=3 and g+h=4;
R=hydrogen atom, alkyl, cycloalkyl, alkenyl, cycloalkenyl, alkynyl, cycloalkynyl, aryl, heteroaryl group or polymer unit, which are in each case substituted or unsubstituted, or further functionalized polyhedral oligomeric silicon-oxygen cluster units, which are attached by way of a polymer unit or a bridging unit,
X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R comprising at least one such group of the type X,
the substituents of the type R being identical or different and there being one substituent of the type X per cluster unit which is reacted with the matrix material, and thereafter the nanofiller is covalently bonded to the matrix material.

31. The matrix as claimed in claim 30,
which comprises as inorganic matrix material, mineral building materials and/or inorganic sinter compositions.

32. The matrix as claimed in claim 30,
which comprises as organic matrix material an elastomer or a thermoplastic or thermoset.

33. The matrix as claimed in claim 30, wherein
the organic matrix material is a plastic or polymer selected from the group consisting of polyethylene, poly-propylene, polyester, copolyester, polycarbonate, polyamide, copolyamide, polyurethane, polyacrylate, polymethacrylate, polymethacrylate copolymer, polysiloxane, polysilane, polytetrafluoroethylene, phenolic resin, polyoxymethylene, epoxy resin, polyvinyl chloride, vinyl chloride copolymer, polystyrene, styrene copolymers, ABS polymer, alkyd resin, unsaturated polyester resin, nitrocellulose resin, rubber and mixtures thereof.

34. The matrix as claimed in claim 30,
wherein
the matrix comprises from 0.05 to 90% by weight of the nanofiller.

35. A process for preparing a matrix as claimed in claim 30, which comprises mixing the nanofiller into a matrix material which is in liquid form and forming by chemical reaction at least one covalent bond between nanofiller and matrix material.

36. The process as claimed in claim 35,
wherein
the nanofiller is mixed mechanically en masse into a polymer melt.

37. The process as claimed in claim 35,
wherein
before being mixed into the matrix material the nanofiller is dissolved in a solvent.

38. A method for producing plastics, sealing compounds, paints, printing inks, adhesives, ceramics, mineral building materials, concrete, mortar, plaster, or coatings of ceramics and plastics, said method comprising:
producing said plastics, sealing compounds, paints, printing inks, adhesives, ceramics, mineral building materials, concrete, mortar, plaster, or coatings of ceramics and plastics which comprises a nanofiller bonded covalently by a chemical reaction to an organic and/or inorganic matrix material, the nanofiller having a size of less than 20 nm and comprising functionalized polyhedral oligomeric silicon-oxygen cluster units of the formula
[(RₐX_{b}SiO_{1.5})ₘ(R_{c}X_{d}SiO)ₙ(RₑX_{f}Si₂O_{2.5})ₒ(R_{g}XₕSi₂O₂)ₐ]
with:
a, b,c=0-1; d=1-2; e, g,f=0-3; h=1-4;
m·b+n·d+o·f+p·h≦4; m+n+o+p≧4; a+b=1; c+d=2; e+f=3 and g+h=4;
R=hydrogen atom, alkyl, cycloalkyl, alkenyl, cycloalkenyl, alkynyl, cycloalkynyl, aryl, heteroaryl group or polymer unit, which are in each case substituted or unsubstituted, or further functionalized polyhedral oligomeric silicon-oxygen cluster units, which are attached by way of a polymer unit or a bridging unit,
X=oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halogen, epoxy, ester, fluoroalkyl, isocyanate, blocked isocyanate, acrylate, methacrylate, nitrile, amino, phosphine group or substituents of the type R comprising at least one such group of the type X,
the substituents of the type R being identical or different and there being one substituent of the type X per cluster unit which is reacted with the matrix material, and thereafter the nanofiller is covalently bonded to the matrix material.
